(19) United States
(12) Patent Application Publication
(10) Pub. No.: US 2009/0096190 A1
(43) Pub. Date: Apr. 16, 2009

(54) Tilting Accessory Hitch With Specific Bearing Design

(76) Inventor: Rodney Warwich Sharp, Hamilton (NZ)

Correspondence Address: YOUNG & THOMPSON, 209 Madison Street, Suite 500, ALEXANDRIA, VA, 22314, US

(21) Appl. No.: 11/793,144

(22) PCT Filed: Dec. 12, 2005
(86) PCT No.: PCT/NZ05/00327

§ 371 Date: Apr. 4, 2008

(30) Foreign Application Priority Data
Dec. 14, 2004 (NZ) NZ 537195
Aug. 25, 2005 (NZ) NZ 542049

(51) Int. Cl. B60D 1/36; F16C 19/02; G01S 1/00

(52) U.S. Cl. 280/727; 384/445; 342/357.06

(57) ABSTRACT

A hitch assembly (1) commonly used between an accessory (such as a front end bucket) and a tractor or prime mover (such as a skid steer loader). The hitch assembly (1) includes a bearing arrangement, partly integral with one of two frame members (2, 3), which allows the two frame members (2, 3) to rotate relative to one another. The two frame members (2, 3) are attached to the tractor via adaptor (61) and the rear of the accessory (eg bucket 60). The bearing portion thus enables rotation of the accessory (60) about an axis substantially parallel to the longitudinal axis of the tractor. Automatic control in conjunction with laser type levelling systems or GPS contouring of sloped surfaces is also possible.

### FIELD OF INVENTION

The present invention is directed to a hitch assembly for the attachment of an accessory to a tractor. The accessory may be a bucket or earthmoving accessory, and the tractor may be a skid-steer loader or comparable machine.

### BACKGROUND DESCRIPTION

Tractors and small loaders, such as exemplified by those manufactured by Bobcat®, Mustang® and Caterpillar® in the USA, are widely used. While versatile models can often accept a variety of different attachments, a front bucket is commonly utilised. This is often used in building construction projects for excavating and removing soil, introducing aggregates, and often also for levelling.

A limitation of most tractor and bucket combinations is that the bucket is fixed in rotational orientation about an axis parallel to the longitudinal axis of the tractor. Accordingly, attempting to level the ground to a particular incline (such as may required in a driveway or courtyard) can be time consuming and greatly dependent on operator skill.

It is known to the applicant that at least one attempt has been made to allow a bucket accessory to be inclined at an angle with respect to the tractor. As an intermediate hitch assembly is typically used between the tractor and accessories such as buckets, the modifications were made to the hitch assembly. However, the arrangement proved difficult and fiddly to use, requiring the user to manhandle components of the hitch to each new preset. This was difficult, and made more difficult if foreign material such as clay or soil clogged the system. While it allowed for rotational bucket inclination, it was not something which could be easily altered (as an operator would want to do). Secondly, it did not allow infinitely variable adjustment within the limits of permitted inclination, and was limited to inclination in one rotational direction only. Thirdly, it was heavy and bulky and increased the depth (front-to-back) of the hitch assembly, and weight.

These last factors are quite significant as they directly influence the load manipulating capacity of the tractor and accessory combination. Even standard hitches are of significant depth, and which results in moving the centre of mass of the tractor and load in bucket, forwardly. This increases the tendency for the tractor to tip forward. Increased weight also introduces similar problems.

The applicant has previously design an embodiment of a tilting hitch assembly which sought to address some of the limitations of the aforesaid manual device. While effective, this design which included a separate attachable rotatable (bearing) assembly, which allowed two frame elements to rotate relative to each other, did suffer from a number of limitations which affected its usefulness and versatility.

For instance, the separate bearing design adopted in the prototypes imposed a number of limitations or disadvantages. One was that the size of the bearing required in order to achieve sufficient strength and rigidity precluded use with accessories having inner mounted hoses (e.g. Bobcat® brand accessories). This was a significant limitation, and attempting to address this problem exposed vulnerable hoses to damage.

The bearing arrangement also resulted in a front to rear dimension for the hitch which was greater than desirable. This results in a number of disadvantages, greatest of which being the fact that the load on the accessory is positioned further forward, upsetting the balance and centre of gravity of the tractor/load combination and possibly requiring counter weighting at the rear of the tractor (reducing the overall performance of the tractor). Any reduction in the thickness of the hitch assembly can yield significant benefits.

The adopted bearing arrangement in the prototypes also influenced rear face design, and the previous model required a specialised plate mount at the rear which restricted use to a user-selected choice of a particular brand of tractor. Providing a hitch assembly which can find universal use amongst a plurality of brands of equipment makers is a useful feature.

From a manufacturing point, the previous design was labour intensive in design, and had several features which localised stress at particular points. This tended to be focused around the bearing. The bearing and mounting design also influenced the design of the frame components, and their ability to manage loads and stress. It was considered of benefit to improve the distribution of stress around any bearing structure.

Accordingly there is a need to provide an improved hitch assembly of reduced depth (front-to back). There is also a need to provide an improved solution allowing for the inclination of a bucket or other accessory to be altered.

Accordingly, it is an object of the present invention to address the above problems.

It is a further object of the present invention to provide a hitch assembly allowing for the variable inclination of an attached accessory, such as a bucket, relative to the tractor with respect to rotation about an axis substantially parallel to the longitudinal axis of the tractor.

At the very least it is an object of the present invention to provide the public with a useful alternative choice.

Aspects of the present invention will be described by way of example only and with reference to the ensuing description.

### GENERAL DESCRIPTION OF THE INVENTION

According to one aspect of the present invention there is provided a hitch assembly for the attachment of an accessory to a tractor, the hitch assembly comprising at least:

a first frame portion attachable to a said tractor, and

a second frame portion to which a said accessory is attachable;

one of said frame portions including a bearing support integrated into its structure and acting as a guide for a rotating bearing portion to which the other frame portion is connected,

the hitch assembly being characterised in that said first and second frame portions are rotatable within a permitted range relative to each other.

According to another aspect of the present invention there is provided a hitch assembly, substantially as described above, in which said bearing support is substantially a section of tube in appearance.

According to another aspect of the present invention there is provided a hitch assembly, substantially as described above, in which said bearing support comprises an arrangement of elements, each substantially arcuate in end section and which collectively, in their position on the frame with which they are associated, form substantially a virtual tube in appearance.

According to another aspect of the present invention there is provided a hitch assembly, substantially as described above, in which said bearing support is a load-bearing or strengthening element contributing to either or both of the strength and rigidity of the frame portion with which it is associated.

According to another aspect of the present invention there is provided a hitch assembly, substantially as described above, in which the bearing support is welded, fused, or otherwise bonded to the frame portion with which it is associated.

According to another aspect of the present invention there is provided a hitch assembly, substantially as described above, in which said rotating bearing portion bears either directly, or indirectly, against the bearing support and is rotatable with respect thereto.

According to another aspect of the present invention there is provided a hitch assembly, substantially as described above, in which the rotating bearing portion is substantially disc-like in appearance, or disc-like with a central removed portion.

According to another aspect of the present invention there is provided a hitch assembly, substantially as described above, in which the rotating bearing portion has a cylindrical central removed portion, and bears against both an inner and outer bearing support attached to a frame portion.

According to another aspect of the present invention there is provided a hitch assembly, substantially as described above, in which a material with a low coefficient of friction is positioned between adjacent faces of a said bearing support and rotating bearing portion.

According to another aspect of the present invention there is provided a hitch assembly, substantially as described above, in which ball or roller bearings are positioned between a bearing support and rotatable bearing portion.

According to another aspect of the present invention there is provided a hitch assembly, substantially as described above, in which a race for the bearings are provided in either or both the bearing support and rotatable bearing element.

According to another aspect of the present invention there is provided a hitch assembly, substantially as described above, in which the rotatable bearing portion includes bearings separating an inner section rotatable with respect to an outer section, either of said inner and outer sections bearing against said bearing support.

According to another aspect of the present invention there is provided a hitch assembly, substantially as described above, which there are provided one or more rings or spacers to help position the rotatable bearing element.

According to another aspect of the present invention there is provided a hitch assembly, substantially as described above, in which a said ring or spacer is removably attachable to a said bearing support.

According to another aspect of the present invention there is provided a hitch assembly, substantially as described above, in which said rotatable bearing portion is removably attachable to the frame portion with which it is associated.

According to another aspect of the present invention there is provided a hitch assembly, substantially as described above, in which the rotatable bearing portion is attachable to said frame portion by bolts.

According to another aspect of the present invention there is provided a hitch assembly, substantially as described above, in which said rotatable bearing portion is integral with, or non-removably attached, the frame portion with which it is associated.

According to another aspect of the present invention there is provided a hitch assembly, substantially as described above, in which said bearing support is associated with said second frame portion.

According to another aspect of the present invention there is provided a hitch assembly, substantially as described above, in which said rotatable bearing portion is associated with said first frame portion.

According to another aspect of the present invention there is provided a hitch assembly, substantially as described above, in which the main body portion of the second frame portion is substantially of open box-like construction.

According to another aspect of the present invention there is provided a hitch assembly, substantially as described above, in which the first frame portion has a main body portion which is substantially planar in appearance.

According to another aspect of the present invention there is provided a hitch assembly, substantially as described above, in which a said bearing support is substantially centrally located within the frame portion with which it is associated, when viewed towards one of its major faces.

According to another aspect of the present invention there is provided a hitch assembly, substantially as described above, in which adjacent faces of the frame portions are substantially coextensive.

According to another aspect of the present invention there is provided a hitch assembly, substantially as described above, in which said first frame portion includes connection means for mounting to a said tractor.

According to another aspect of the present invention there is provided a hitch assembly, substantially as described above, in which said second frame portion includes connection means for mounting an accessory.

According to another aspect of the present invention there is provided a hitch assembly, substantially as described above, in which the accessory is a bucket.

According to another aspect of the present invention there is provided a hitch assembly, substantially as described above, wherein the tractor is a loader.

According to another aspect of the present invention there is provided a hitch assembly, substantially as described above, in which orientation means is provided for setting and/or maintaining the relative orientation of said frame portions.

According to another aspect of the present invention there is provided a hitch assembly, substantially as described above, in which the orientation means is manually adjusted.

According to another aspect of the present invention there is provided a hitch assembly, substantially as described above, in which the orientation means comprises a rack type system, a cam arrangement, or a screw and nut type arrangement.

According to another aspect of the present invention there is provided a hitch assembly, substantially as described above, in which the orientation means comprises one or more rams.

According to another aspect of the present invention there is provided a hitch assembly, substantially as described above, in which the orientation means is hydraulic in operation.

According to another aspect of the present invention there is provided a hitch assembly, substantially as described above, in which the orientation means is remotely controllable from the cab of the tractor, or elsewhere on the tractor.

According to another aspect of the present invention there is provided a hitch assembly, substantially as described above, in which the orientation means comprises a hydraulic ram connected at each end to different of the two said frame portions.

According to another aspect of the present invention there is provided a hitch assembly, substantially as described above, in which the orientation means is remotely controllable by a control circuit.

According to another aspect of the present invention there is provided a hitch assembly, substantially as described above, in which the control circuit has sensor inputs comprising light detectors sensitive to light generated by a laser type levelling sending device, the control circuit evaluating this information to control the orientation means.

According to another aspect of the present invention there is provided a hitch assembly, substantially as described above, in which two such light detectors are provided and are mounted to said second frame portion.

According to another aspect of the present invention there is provided a hitch assembly, substantially as described above, in which the control circuit is in communication with a GPS positioning arrangement to determine the position of either or both the tractor and a mounted accessory; the control circuit also having provision for receiving data comprising a contour map; the control circuit evaluating GPS and contour map data to control the orientation means.

According to another aspect of the present invention there is provided a hitch assembly, substantially as described above, in which the control circuit has outputs for controlling the elevation of a hitch and assembly mounted on the tractor.

According to another aspect of the present invention there is provided a hitch assembly, substantially as described above, in which the control circuit has an output for providing information to a display unit visible to an operator.

According to another aspect of the present invention there is provided a hitch assembly, substantially as described above, in which the display unit includes information guiding an operator regarding orientation of the hitch assembly.

According to another aspect of the present invention there is provided a hitch assembly, substantially as described above, which includes rams for effecting release of accessory mounting pins.

According to another aspect of the present invention there is provided a hitch assembly, substantially as described above, in which the pin releasing rams are hydraulic in operation.

According to another aspect of the present invention there is provided a hitch assembly, substantially as described above, in which the pin releasing rams are remotely operable from the cab of the tractor or elsewhere on the tractor.

For the purposes of this specification, a ‘tractor’ is defined as being any powered vehicle, wheeled and/or tracked, to which a utility accessory—such as a loader bucket, etc.—is attachable. This definition includes vehicles occasionally referred to as loaders, or backhoe machines, and in particular includes skid-steer loaders and loaders of the type such as manufactured by Bobcat®, Mustang® and Caterpillar® in the USA. Also included are smaller vehicles and devices such as manufactured by Dingo® of Australia.

The present invention comprises a hitch able to used intermediate a tractor and an accessory to provide additional function to the accessory. The additional function is the ability to rotate the accessory, normally within a limited range, about an axis parallel to the longitudinal axis of the tractor.

More specifically the present invention allows for alteration of the relative rotational orientation of the accessory about an axis which is generally parallel to the longitudinal axis of the tractor (in a typical mounting installation). The degree of rotation may be limited, and is often limited by the design and choice of components for orientation means which sets and/or maintains the degree of rotation. While an extensive rotation range of ±45° from standard level orientation may be provided, it is envisaged that most embodiments will be within a lesser range of ±22.5°, and preferably within ±10°. For most applications it is envisaged that inclinations (angles of rotation) of less than 6° will be required, with only special circumstances or applications requiring greater angles.

The hitch of the present invention comprises what shall conveniently be referred to as first and second frame portions. The term ‘frame’ should be used in its broadest sense and may comprise merely a plate, or a more complex arrangement. In essence, the ‘frame’ should be a construction able to perform the functions required of it. These functions, which shall become more apparent from the description given herein, will typically involve acting as a supporting structure between various components to which it is coupled.

In the hitch of the present invention the two frame portions are able to rotate relative to one another. Preferably, one of the frame portions is associated with the tractor, and is coupled or connectable thereto. The other frame portion is associated with the accessory, to which it is coupled or connectable. Intermediate adaptor portions may be provided which attach to a frame portion and allow it to attach to the tractor, and/or an accessory. These can be used to enable an embodiment of the invention to be used on a range of different manufacturer's tractors. It should be envisaged that mounting arrangements for a particular brand of tractor, or accessory, may also be provided on a frame portion itself—see below.

In preferred embodiments of the present invention the frame portion associated with the tractor comprises a ‘universal’ type back. To this back may be fitted different adaptor assemblies which allow the hitch to be mounted to different brands of tractors which may use specific or proprietary accessory mounting arrangements. The back may also be configured to fit with a specific mounting arrangement (with the option of fitting various adaptor assemblies for other mounting arrangements), or may include semi-permanently or permanently fixed adaptor assemblies.

The present invention achieves accessory angular adjustment by allowing for relative rotation of the frame portions. This is achieved in preferred embodiments of the present invention by at least partially integrating a bearing structure into one of the frame portions. This may be either of the frame portions, though for simplicity of description we shall discuss an arrangement (unless otherwise stated) where the bearing integration is associated with the frame portion coupleable to the accessory. The detailed description will describe an alternative embodiment where the bearing is primarily integrated into the frame portion coupleable to the tractor. This arrangement is not practicable for a number of tractors, as the components of the frame would interfere with componentry on the tractor. However, on some models this problem doesn't exist and this alternative embodiment type may be used. In some instances part of the bearing structure can be positioned further back, within recesses provided under the tractor. The result can be that the front of the accessory frame portion can be positioned further back (with respect to the longitudinal axis of the tractor)—an advantage in terms of keeping the centre of mass (when there is a loaded bucket) further back, and thus further reducing any need for counter weighting.

There are different ways of at least partially integrating a bearing with a frame portion. In preferred embodiments of the present invention, a support for a bearing assembly is integrated into (what we shall refer to as the ‘front’) frame portion. In preferred embodiments this support is cylindrical (or more specifically with a cylindrical removed inner portion) in nature, and is welded or fused to the frame portion. Other fabrication techniques may integrally cast the support with the frame portion, or bond the support to the frame portion in other ways. However, consideration needs to be given to the relationship between the support and frame portion when considering construction and fabrication.

For instance, trials with earlier embodiments of a tilting hitch indicated that extremely high stresses were generated around the connection of the bearing to frame portions. In a previous bolted separate bearing arrangement, high stresses were concentrated locally and were a concern. This also imposed requirements on strengthening the apparatus to address these stresses. Simulations and analyses on designs for preferred embodiments of the present invention have shown that these stresses are now more evenly distributed about the support, and avoid localised stress hotspots. This represents a significantly realisable advantage, particularly in terms of product durability, and simplifying construction (by not having to address stress hotspots by strengthening).

A further potential advantage has also been realised in relation to integrating at least the bearing support to a frame portion. The arrangement significantly contributes to the strength and rigidity of the associated frame portion, and allows the applicant to avoid the necessity of manufacturing all frame portions with significant ribbing or of box construction for strength and rigidity. As a consequence, the front frame portion can be of relatively light open-box construction, useful for housing the hydraulic accessory release cylinders in preferred embodiments. Also now, the rear frame can be formed substantially of a plate, which is a significant and important factor in allowing the front to rear dimensions of the hitch assembly to be reduced. As previously mentioned, this dimension has a significant bearing on the performance of a tractor fitted with an intermediate hitch and accessory—the greater the thickness of the hitch, the further forward the accessory is displaced and the less the load carrying ability (and greater the counterbalancing required) of the tractor.

The present invention also reduces the area occupied by the bearing assembly and its associated mounting component on the frame. This is significant in terms that the new invention now accommodates inside hose connections—i.e. hydraulic hoses which connect within the perimeter of the hitch assembly as opposed to at or near the outside thereof. As approximately 70% of all tractor and accessory units are estimated to use inside hose connections, this represents a significant increase in the versatility of the present invention as compared to previous embodiments.

There are some other manufacturing advantages which may be realised with the aforesaid arrangement. For instance, the bearing support may be pre-machined prior to being welded in (in preferred embodiments), avoiding the need for post-machining. Secondly, the previous design of the applicant required the accurate machining and alignment of mounting holes when a separate bearing assembly was used. Typically these holes were drilled after the bearing was in position, and was a difficult and time consuming step from a manufacturing viewpoint. These steps can now be eliminated. Additionally the use of a plate type rear frame substantially reduces welding time as it eliminates (in the preferred embodiment) the need to weld strengthening ribs and components for box structures. All of this welding required significant jigging to avoid distortion, and could occasionally require post-weld straightening. The ability to adopt a plate-like rear design in preferred embodiments has significantly reduced the amount of associated welding, and reduced the need for jigging or any post-weld straightening. These are significant factors in fabrication times and costs.

Consequently, it can be seen that in preferred embodiments of the present invention the bearing support can also act as a load-bearing, load-transmitting, and/or strengthening component.

While the bearing support in preferred embodiments is cylindrical and represents a tubular section, other arrangements may be used in other embodiments. For instance, a series of arcuate elements (when viewed from their end) may be arranged to substantially form a tube section if the ends of the arcs were connected—effectively a virtual tube. Other arrangements may also be considered, though often at the expense of any additional strengthening that a true tubular section would provide.

To complete the bearing arrangement in preferred embodiments, there is positioned within the bearing support a rotating bearing portion. In its simplest and preferred form this represents merely a disc dimensioned to be able to rotate within the cylindrical interior of the bearing support. More preferably the rotating bearing portion has a removed central portion making it annular in appearance.

The peripheral edge of the rotating bearing portion may bear directly against the interior of the bearing support, relying on suitable lubricants to ease relative rotation. In other arrangements one or both contacting surfaces may be treated with a material of a low coefficient of friction (e.g. PTFE), or may comprise different metals which offer a lowered coefficient of friction when used together. An intermediate sleeve which reduces friction may also be considered.

The inside of the bearing support may also be hardened to reduce wear, or lined with a sleeve of a hardened material.

In another arrangement the periphery of the rotating bearing portion may be modified to form a race for bearings such as roller or ball bearings. The internal face of the bearing support may also be modified to support such an arrangement. The rotating bearing portion may in itself comprise a bearing assembly whose outer periphery bears against the inside of the bearing support. As can be appreciated, a number of arrangements may be employed in the present invention.

At least part of the rotating bearing portion, which rotates relative to the bearing support, will be affixed to the rear frame (in the arrangement being discussed). This can be accomplished in a variety of manners, though in a preferred arrangement the rotating bearing portion is bolted to the rear frame. Welding or bonding methods may be used, though consideration may need to be given to subsequent removal of the rotating bearing portion for maintenance or repair.

Consideration needs also to be given to retaining the rotating bearing portion within the bearing support. While a variety of mechanical arrangements may be put in place for preventing separation of the front and rear frame portions, in the preferred arrangement this performed at the bearing arrangement. In a preferred arrangement a spacer is used between the rear frame portion and the rotating bearing portion. Bolts connect the three components to each other, preventing separation. As the spacer is of lesser diameter than the inside of the bearing support, there is room for a further retaining ring in the void. A ring retaining device, such as a wire accommodated in grooves in both the retaining ring and bearing support, maintains the retaining ring in position. As the retaining ring bears against least part of the rotating bearing portion, and either the rear frame or an elevated portion of the spacer, it locks the connected components against movement in a forward or reverse direction—thus helping maintain the front and rear frames in their preferred positions and against separation.

In other arrangements the retaining ring could be fixed directly to the bearing support, spacer or rear frame, though the aforesaid arrangement allows the retaining ring to rotate independently of the others, helping to reduce friction relative to these other components. Additionally, for maintenance it is desirable that an arrangement is used where the retaining ring can be removed.

As should also be appreciated, other arrangements may be relied upon for preventing separation of the front and rear frame portions, or the bearing components, and may be employed in various embodiments of the present invention.

Once assembled into position, the hitch assembly should comprise two frame portions, ideally positioned front and rear (when attached to the tractor in a typical installation), and able to rotate relative to each other.

To set and maintain the relative degree of rotation of the frame portions, orientation means is used. While manual setting and adjustment means are envisaged, preferred embodiments utilise a powered ram—preferably hydraulically powered or operated—to control rotational orientation. This may be a dual acting ram which is ideally connected at each end to alternate of the frame portions. A pair of opposing rams or other arrangements may be considered.

In trials with previous designs the hoses to the rotation controlling ram were positioned at the top of the hitch assembly, and external to the frame portions. However it was found that this could introduce complications—for instance they were prone to getting caught on branches, concrete reinforcing bars, and other obstacles. This could result in damage to the hoses and require repair of the apparatus. Accordingly, in preferred embodiments, the hoses to this ram are now located internally and preferably within the frame portions.

Utilising hydraulic control also allows for remote operation of the device controlling orientation, such as driver control from the tractor's cab. While other powered arrangements, including electrical control, is possible it is noted that most accessory control systems on tractors are hydraulic in operation and hence there is a preference to remain with hydraulic operation.

The use of powered control of orientation adjustment also allows the invention to be modified to use auto-levelling control systems. Laser guided levelling systems are becoming more commonly used, one common rotary laser system using a laser to emit a planar emission at the true horizontal or desired inclination. By providing sensors, ideally coupled to match the actual inclination of the accessory, these can determine if the inclination of the bucket/accessory matches the level/inclination of the guiding laser emitted plane. Coupling the sensors to a simple control circuit controlling the accessory inclination power means (e.g. the hydraulic ram and circuitry), the inclination of the accessory can be continually adjusted to ensure that it matches that of the guiding laser plane. Alternatively a visual display can relay appropriate information to the operator so that they can manually adjust the inclination (and optionally also height).

Such laser devices, along with detectors, are commonly available and may be adapted for use with the present invention. Using an array detector—e.g. a central (optimum target) sensor, and drift sensors (to detect if the laser plane is drifting away from the target sensor) above and below the central detector—would allow the control circuit to determine what adjustments may need to be made to alter the inclination of the accessory. Additionally, if no inclination change is necessary, but the height is incorrect, the control circuit may be further modified to control other aspects of the hydraulic circuit—i.e. to control the lifting and lowering of the bucket.

Ideally at least two sensors or sensor arrays are provided, and preferably near each end of the frame portion to which the accessory is attached. They may be mounted on stalks to raise them to the correct height for the laser emitter.

Another arrangement is to use a GPS system, where a contour map is loaded to be accessible to the control circuit. Using GPS positioning, the control circuit can then determine the correct inclination and elevations that the ground should be. Such GPS systems and contour mapping technology are commercially available, and becoming more widely so. In the context of the present invention it represents a means of more accurately contouring the ground through automated control, though initial ‘rough’ contouring of a site may typically still be performed manually by a skilled operator. The various automated control systems can provide a visual indication of approximate contours—e.g. if the ground needs to be raised or lowered at a particular position.

Additional features may be provided on preferred embodiments of the present invention. One disadvantage of the prior art attachment devices is their front-to-back depth. The greater this is, the more forwardly a load will shift the centre of mass of a vehicle with load. This has an effect on its load carrying capacity and can cause the tractor to tip forward. Often this front-to-back depth is determined by the need to manually operate the accessory releasing pins, which are relatively standard for accessory attachment. These generally comprise lever and ratchet arrangements for pin release, but increase front-to-back depth primarily by the need to provide sufficient hand space for a user to reach in and operate the lever. Keeping the lever above the top of the hitch assembly merely exposes to a significant risk of damage, the result being an inability to release the bucket or other accessory.

The dual frame arrangement of the present invention also introduces considerations, as two frames are of thicker construction than one, despite the advances made in the present invention. Accordingly, these considerations have been addressed by the provision of hydraulically operated lower accessory pins. A single ram, associated with each pin, is used to lift each pin to effect release of the accessory. Biasing means associated with each pin (to return to the downward position) may be retained.

Preferred embodiments also incorporate a non-return, or check, valve for each of the cylinders associated with the accessory pins. This can provide a safety advantage in the event the hose damage, hose failure, or hydraulic pump failure occurs. Here the accessory pins will remain in place, rather than releasing the accessory and its load.

This arrangement, which may also be implemented on hitch assemblies of standard and known type construction, can significantly reduce the depth (front-to-rear) of hitch assemblies and increase the load manipulating performance of the tractor/accessory combination. The arrangement also allows for the remote release of the accessory if the user so desires—e.g. through control from within the tractor's cab (or elsewhere on the tractor).

### DESCRIPTION OF DRAWINGS

FIG. 1 a perspective cutaway view of an embodiment of the present invention,

FIG. 2 is a perspective view of the rear of the embodiment of FIG. 1,

FIG. 3 is a perspective, partial cutaway view, of the front of the embodiment of FIG. 1,

FIG. 4 is the view of FIG. 3, with the cover plate in place,

FIG. 5 is a perspective cutaway view of an embodiment of the present invention, with the bearing assembly in place,

FIG. 6 is a perspective separated view of the embodiment of FIG. 1, and showing also a typical mounting adaptor attachable to a loader, and the rear of a typical bucket accessory,

FIG. 7 is a perspective view of the embodiment of FIG. 1 with the frame portions rotated relative to each other,

FIG. 8 is a front view towards the first frame portion, of the embodiment of FIG. 1,

FIG. 9 is a partial cross-sectional view of an alternative embodiment of the present invention, focusing on the bearing arrangement, and

FIG. 10 is a schematic of a control arrangement in an auto-levelling or auto-contouring embodiment.

### BEST METHODS OF PERFORMING THE INVENTION

### Example 1

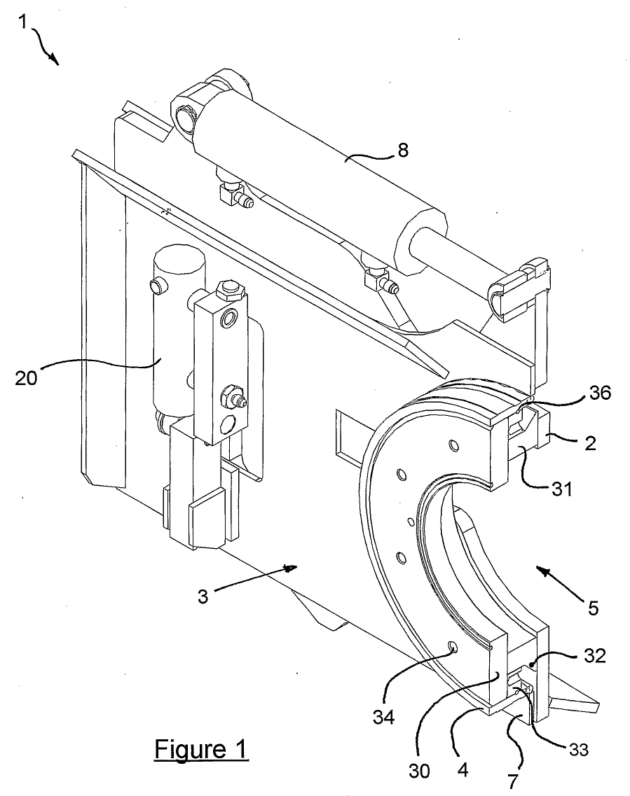

With reference to the drawings, and by way of example only, there is illustrated an embodiment of the present invention. FIG. 1 provides a cutaway view, which enables various components of the embodiment to be seen.

Referring to FIG. 1 there is shown a hitch assembly (generally indicated by arrow 1), which comprises a first frame portion (including element 2) attachable to a tractor (not shown) and a second frame portion (generally indicated by arrow 3) to which an accessory (not shown) is attachable. The second frame portion (3) supports an integral bearing support (4) which is annular and continuously welded to back plate (7) of frame portion (3). This acts as a guide for a rotating bearing portion (generally indicated by arrow 5) which is connected to the other frame portion (2). This arrangement allows the frame portions (2, 3) to rotate relative to each other, within a limit defined by controlling cylinder (8), about an axis generally central to and perpendicular to the major planes of the frame portions (2, 3).

The first frame portion comprises substantially a plate element (2) with cutaway portions to reduce weight. These cutaways should be positioned not to compromise strength, which will also be a factor of the thickness and type of material (generally a steel) chosen for the plate (2). A plurality of apertures (10) allow for connection by mechanical fasteners (e.g. high tensile bolts) to the bearing portion (5).

The plate (2) includes top (11) and bottom (12) features to enable attachment to a tractor. These features may be selected to be compatible with a particular brand or range of tractors, though universal mounting locations are preferred.

An upward arm extension (15) provides a mounting point for controlling hydraulic cylinder (8) which controls the relative rotation of the frame members (2, 3). This cylinder (8) is connected at its alternate end to an arm (15) associated with the second frame portion (3). The positioning of these components (2, 3, 8) should be such that they do not interfere with the normal operation and range of movement of an attached accessory.

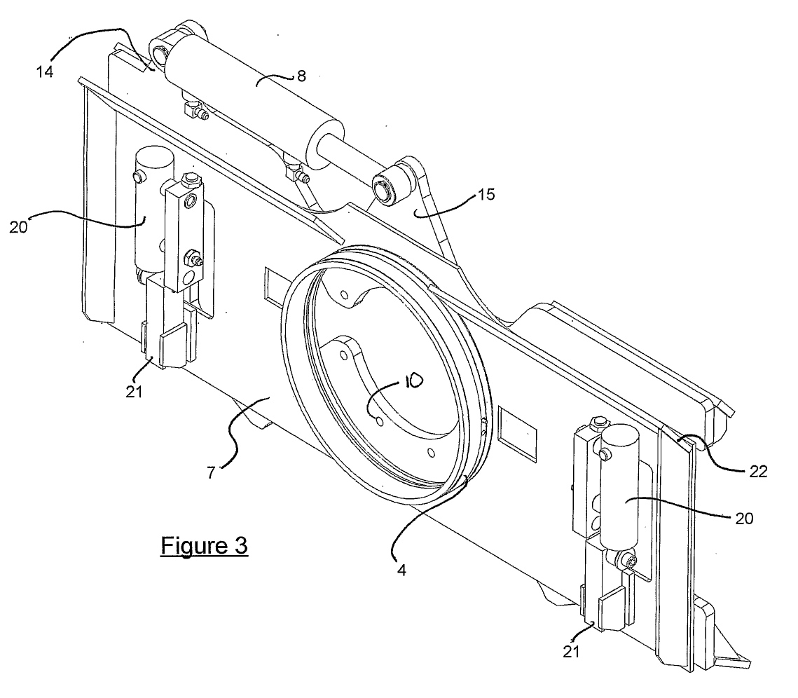

FIG. 3 illustrates the second frame portion (3) with its cover plate (16) removed. This allows us to view the hydraulic release cylinders (20) which each act on a lower retaining pins (21) on each side. These pins (21) help retain the accessory. Each cylinder (20) raises its associated pin to enable release of an attached accessory. As for rotation controlling cylinder (8), these cylinders are remotely controllable from outside of the hitch assembly, and ideally from within the cab of a tractor. The combination of the pins (21) and angled portion (22) at the top of the frame (3) enable the attachment of an accessory.

The bearing arrangement (5) includes an annular disc-like bearing portion (30) adjacent an annular spacer (31). The spacer (31) has a ramped portion (32) which helps locate, and maintain in position, a retaining ring (33). Apertures (34) pass through the rotating bearing portion (30) and spacer (31), to connect to apertures (10) on plate element (2). Connecting bolts fasten these three components together.

As can be appreciated, the retaining ring (33) can rotate relative to both these three components (2, 30, 31), and the bearing support guide (4). A retaining wire (36), positioned in a groove in both the retaining ring (33) and support/guide (4) prevents the retaining ring (33) from moving forwards or backwards relative to the bearing support (4). As the support (4) is substantially integral with front frame portion (3), it is also locked against forward or rearward movement relative to the frame (3). The relationship between the bearing element (30) and the ramp (32) on spacer (31), means that these components (and the other frame element (2) to which they are fastened) are also locked against forward or rearward movement relative to the bearing support guide (4). Thus the two frame portions (2, 3) are prevented from separation.

In operation the apparatus (1) is attached to be intermediate an accessory and tractor. Operation of cylinder (8) controls the relative rotation of the accessory relative to the tractor. Release cylinders (20) acting on release pins (21), in this embodiment, facilitate the release of the accessory when required. For maintenance of the bearing arrangement, the bolts passing through apertures (10, 34) are removed, allowing separation and removal of bearing portion (30), spacer (31) and rear plate (2). The retaining ring (33) can be knocked out if required for any maintenance. This allows inspection and replacement of bearing components, increasing the versatility and usefulness of the arrangement of the present embodiment.

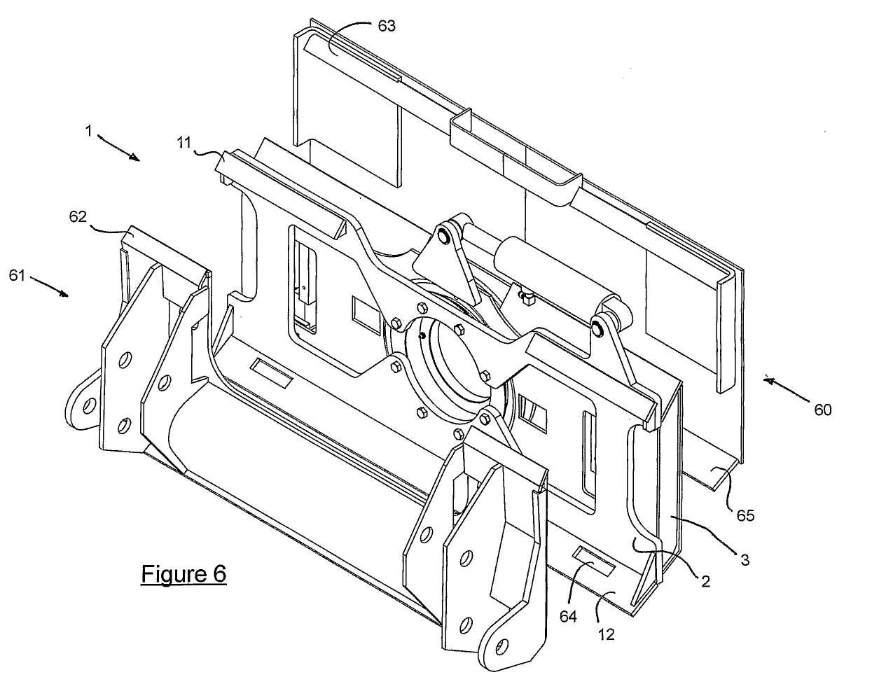

FIG. 6 illustrates the frame portion (1) intermediate the rear (60) of a bucket (only the rear shown for simplicity) and a mounting adaptor (61) likely to be attached to the front arms of a typical skid steer loader (not shown). As can be seen the attachment features of the hitch assembly (1) mimic those of the mounting adaptor (61) and accessory (60)—the adaptor (61) could be attached directly to the accessory (60) or the hitch (1) can be positioned intermediate therebetween.

For instance the top inclined feature (62) of the adaptor (61) can interact with the downwardly inclined feature (11) on the hitch assembly, or the equivalent feature (63) on the accessory (60). Pins (not visible) at the bottom of the adaptor (61) fit into slots (64) on the hitch assembly (1), and are mimicked by the hitch assembly's pins (21) which fit into equivalent slots (not visible) on the bottom inclined feature (65) on the accessory (60). This arrangement allows this embodiment of a hitch assembly (1) to be readily used on existing loader arrangements without any significant modification, merely being able to be inserted between an existing adaptor (61) (which may be permanently fixed or mounted to the loader) and an accessory.

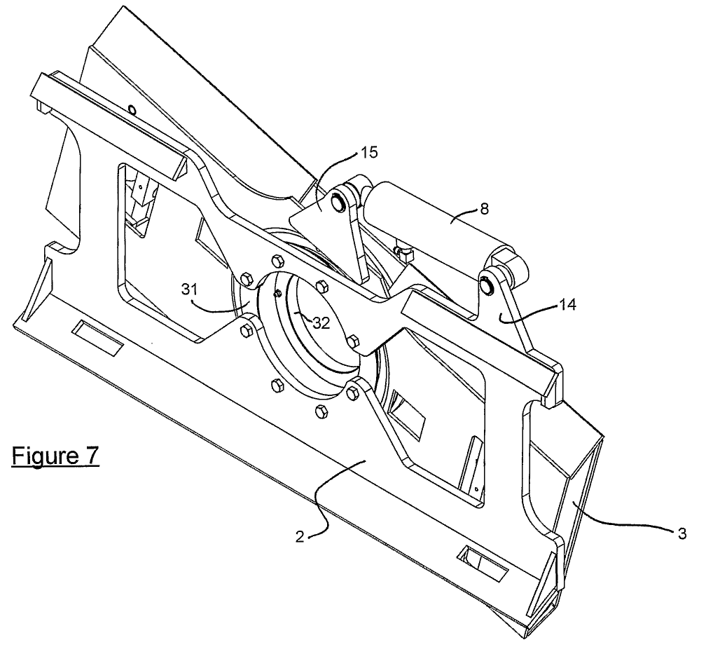

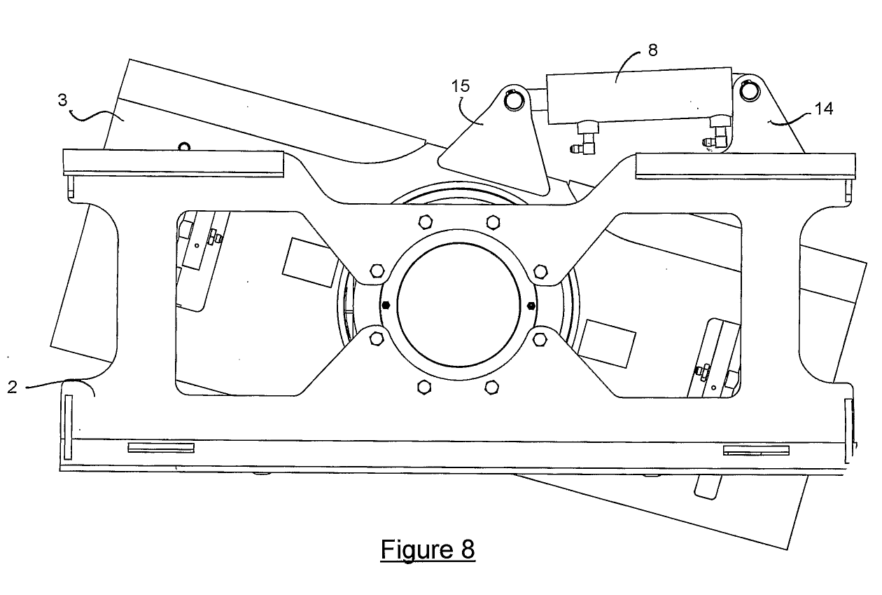

FIG. 7 illustrates the embodiment of FIG. 1 with the frame portions (2, 3) rotated relative to each other by action of the top cylinder (8). This more clearly illustrates the rotational ability of the illustrated embodiment, noting that the frame portions can also be rotated in the other direction. FIG. 8 provides an alternative view of the rotated portions.

### Example 2

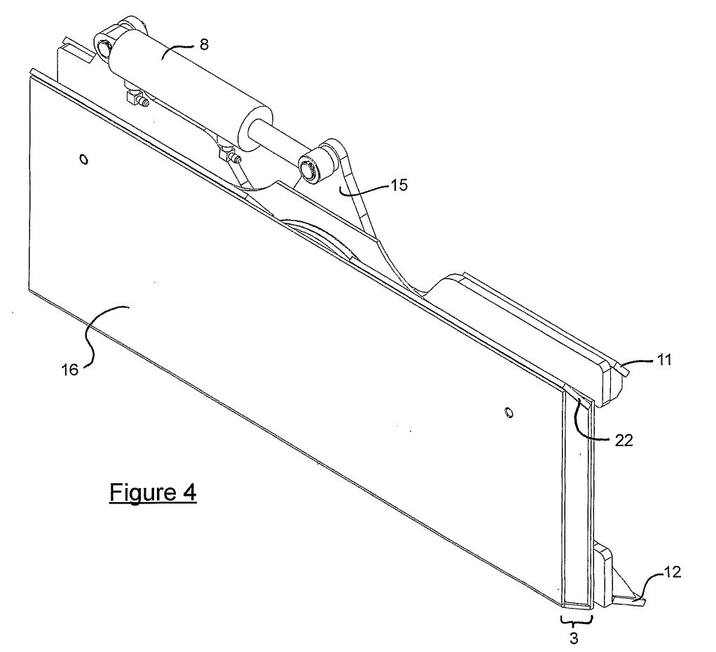

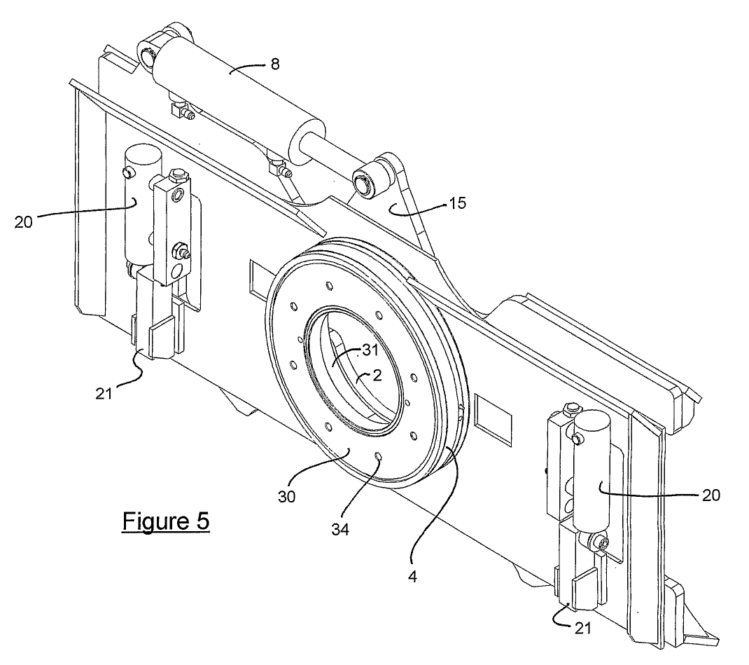

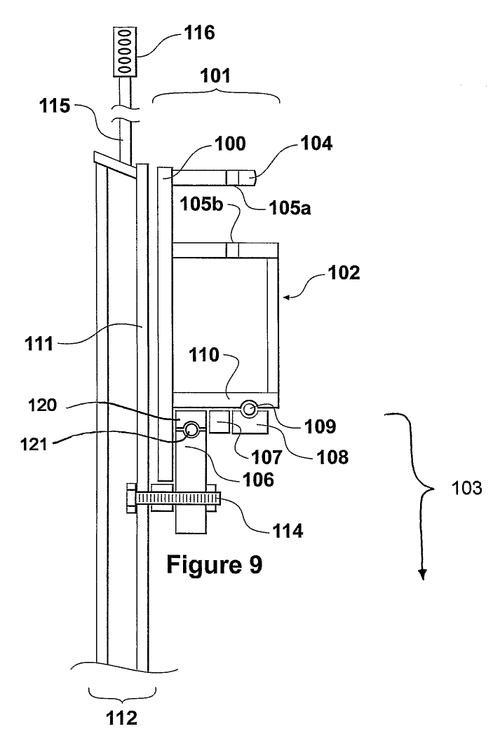

FIG. 9 is a partial cross-sectional view of an alternative embodiment in which the bearing arrangement is integrally mounted of the rear frame portion—i.e. that portion connectable to the tractor. Reference will be made to FIGS. 1 through 8 as many elements of the two examples are equivalent—the primary difference being the bearing arrangement of the two examples.

Main plate (100) provides the main strength of the rear frame portion (generally indicated by numeral 101). Depending from the rear of plate (100) is a box frame section (generally indicated by arrow 102) for additional strength and rigidity. This can be provided both above and below the central bearing arrangement (generally indicated by numeral 103). Additional member (104) provides one of the apertures (105a, b) for the mounting pin of the tilt cylinder (i.e. see cylinder (8) in FIG. 1).

Extending inwardly of the plate (100) is the bearing support (110), the equivalent of support (4) in FIG. 1. Positioned behind plate (100) is the bearing ring (106), the equivalent of ring (30) in FIG. 1. Here the ring (106) includes a rotating outer section (120) separated by a plurality of ball bearings (121) in a race. This further reduces the rotational friction between the rotating inner bearing ring section (106) and the bearing mount (110). Optionally a spacer may be positioned to distance the bearing ring (106) from any contact with plate (100). Additionally also, multiple rows of bearings (121) may be provided on other embodiments. This inner (106) and outer (120) section option may also be provided on embodiments corresponding to example 1, while other embodiments of example 2 may have the bearing ring arrangement of FIG. 1 (30).

Behind this (106) is situated an optional annular spacer (107) separating the ring (106) from retaining element (108)—the equivalent of retaining ring (33) in FIG. 1. A groove is provided in both the bearing support (110) and retaining ring (108) to accommodate retaining wire (109). This arrangement maintains the bearing ring (106) in position, but able to rotate within the bearing support (110). The hollow centre allows hoses and services to pass through to the front if needed.

Forward of plate (100) is the forward frame assembly (generally indicated by numeral (112). The rear plate (111), equivalent to plate (3) in FIG. 1, is fixed to the bearing ring (106) by a series of bolts (114) distributed in a circular pattern—equivalent to the arrangement of FIG. 1 (see bolt apertures 34).

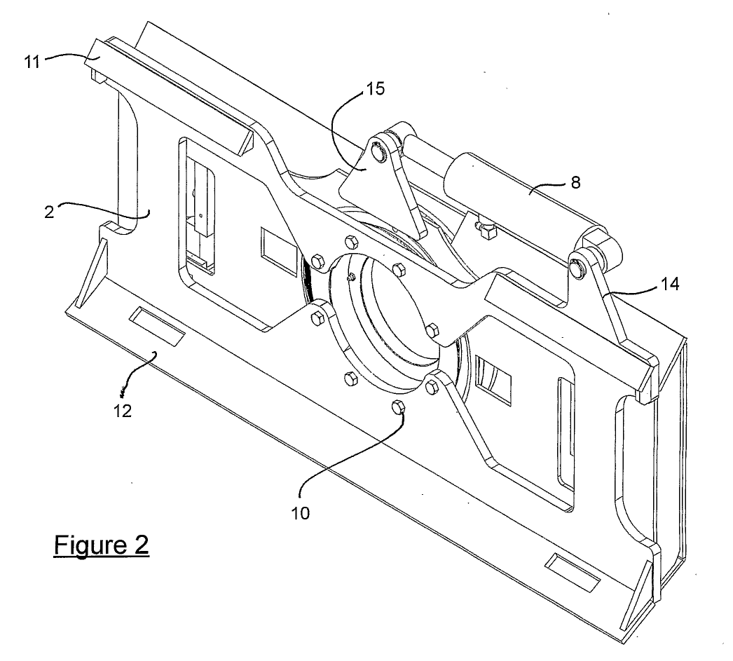

The front frame assembly (112) is adapted for the connection of an accessory. Reference may be made to FIG. 1 et al for the preferred general design of the front frame portion. Similarly, features such as shown in FIG. 1 et al, may also be implemented in the embodiment of FIG. 2—for simplicity, features such as the release cylinders (20) and arrangement are not shown in FIG. 9. It is envisaged that the skilled reader will be able to adapt the content of FIGS. 1 through 8, and related description herein, to complete the design of the embodiment of example 2 (which differs primarily in the bearing arrangement, as illustrated).

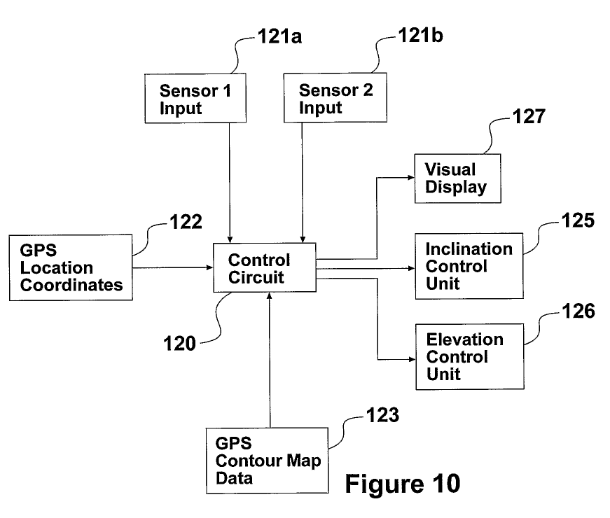

Rising from the front frame portion (112) are stalks (115) which have a sensor array (116) at the top. One such arrangement is positioned at or near the left and right ends of the frame portion (112). These sensors (116) are adapted to react to a laser sending device (e.g. rotary levelling laser) and communicate with a control device (120) such as illustrated in FIG. 10.

FIG. 10 is a control circuit schematic of a possible embodiment of the present invention. Not all embodiments may include provision for GPS control, though for the purposes of simplicity and illustration this schematic shows both laser and GPS input.

Two laser sensor/detector array inputs (121a, b) feed signals for evaluation by the control circuit (120). Here GPS location information from a GPS locator (122) is also able to be fed to the control circuit (120). In GPS embodiments there is generally also provision for uploading data in the form of a contour map (123). Using information fed to it, the control circuit controls the inclination of the front frame assembly and hence the accessory (125). Additionally, elevation control of the accessory may be optionally provided (126) allowing for more complete automated control of an accessory.

Optionally also may be provided a visual display (127) for the operator. This may be a simple gauge through to a sophisticated monitor display. This can provide a wide variety of information, such as deviance from the desired position, what the control circuit is doing, and requests from the control circuit for manual intervention or over-ride. Even when not in an automatic mode, such a display can provide visual instructions/assistance for an operator to assist in manual operation of the tractor and accessory.

Aspects of the present invention have been described by way of example only and it should be appreciated that modifications and additions may be made thereto without departing from the spirit or scope of the present invention as described herein.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being authoritative disclosure on the true state of the prior art but rather as referencing considerations brought to the mind and attention of the inventor when developing this invention, and neither does it represent any admission or indication of prior art publicly available in any jurisdiction.

1-49. (canceled)

50. A hitch assembly for use in the attachment of an accessory to a tractor, the hitch assembly comprising at least:
a first frame portion attachable to a said tractor, and
a second frame portion to which a said accessory is attachable;
one of said frame portions including a bearing support integrated into its structure and acting as a guide for a rotating bearing portion to which the other frame portion is connected,
the hitch assembly being characterised in that said first and second frame portions are rotatable within a permitted range relative to each other.

51. A hitch assembly as claimed in claim 50, there being included a mounting adaptor attachable to the first frame portion, said tractor attaching to or having attached the mounting adaptor.

52. A hitch assembly as claimed in claim 50, there being included a mounting adaptor integral with the first frame portion, said tractor attaching to or having attached thereto the mounting adaptor.

53. A hitch assembly as claimed in claim 50, in which said bearing support comprises an arrangement of elements, each substantially arcuate in end section and which collectively, in their position on the frame with which they are associated, form substantially a virtual tube in appearance.

54. A hitch assembly as claimed in claim 50, in which said bearing support comprises a load-bearing or strengthening element contributing to either or both of the strength and rigidity of the frame portion with which it is associated.

55. A hitch assembly as claimed in claim 50, in which the bearing support is welded, fused, or otherwise bonded to the frame portion with which it is associated.

56. A hitch assembly as claimed in claim 50, in which said rotating bearing portion bears either directly, or indirectly, against the bearing support and is rotatable with respect thereto.

57. A hitch assembly as claimed in claim 50, in which the rotating bearing portion is substantially disc-like in appearance, or disc-like with a central removed portion.

58. A hitch assembly, as claimed in claim 57, in which the rotating bearing portion has a cylindrical central removed portion, and bears against both an inner and outer bearing support attached to a frame portion.

59. A hitch assembly as claimed in claim 50, in which a material with a low coefficient of friction is positioned between adjacent faces of a said bearing support and rotating bearing portion.

60. A hitch assembly as claimed in claim 50, in which ball or roller bearings are positioned between a bearing support and the rotatable bearing portion.

61. A hitch assembly as claimed in claim 50, in which a race for the bearings are provided in either or both the bearing support and rotatable bearing element.

62. A hitch assembly as claimed in claim 50, in which the rotatable bearing portion includes bearings separating an inner section rotatable with respect to an outer section, said outer section bearing against said bearing support.

63. A hitch assembly as claimed in claim 50, in which there are provided one or more rings or spacers to help position the rotatable bearing element.

64. A hitch assembly, as claimed in claim 63, in which a said ring or spacer is removably attachable to a said bearing support.

65. A hitch assembly, as claimed in claim 64, in which the removably attachable arrangement allows rotation of said ring or spacer with respect to said bearing support.

66. A hitch assembly as claimed in claim 50, in which said rotatable bearing portion is removably attachable to the frame portion with which it is associated.

67. A hitch assembly, as claimed in claim 66, in which the rotatable bearing portion is attachable to said frame portion by bolts or mechanical fasteners.

68. A hitch assembly as claimed in claim 50, in which said rotatable bearing portion is integral with, or non-removably attached to, the frame portion with which it is associated.

69. A hitch assembly as claimed in claim 50, in which said bearing support is associated with said second frame portion.

70. A hitch assembly as claimed in claim 50, in which said rotatable bearing portion is associated with said first frame portion.

71. A hitch assembly as claimed in claim 50, in which the main body portion of the second frame portion is substantially of open box-like construction.

72. A hitch assembly as claimed in claim 50, in which the first frame portion has a main body portion which is substantially planar in appearance.

73. A hitch assembly as claimed in claim 50, in which a said bearing support is substantially centrally located with respect to the frame portion with which it is associated, when viewed towards one of its major faces.

74. A hitch assembly as claimed in claim 50, in which adjacent faces of the frame portions are substantially coextensive.

75. A hitch assembly as claimed in claim 50, in which said second frame portion includes connection means for mounting an accessory.

76. A hitch assembly as claimed in claim 50, in which orientation means is provided for setting and/or maintaining the relative orientation of said frame portions.

77. A hitch assembly, as claimed in claim 76, in which the orientation means is manually adjusted.

78. A hitch assembly, as claimed in claim 77, in which the orientation means comprises at least one of: a powered rack type system, a powered cam arrangement, or a powered screw and nut type arrangement.

79. A hitch assembly, as claimed in claim 78, in which the orientation means comprises one or more rams.

80. A hitch assembly, as claimed in claim 79, in which the orientation means is hydraulic in operation.

81. A hitch assembly, as claimed in claim 79, in which the orientation means comprises a hydraulic ram connected at each end to different of the two said frame portions.

82. A hitch assembly, as claimed in claim 79, in which the orientation means is remotely controllable from the cab of the tractor, or elsewhere on the tractor.

83. A hitch assembly, as claimed in claim 79, in which the orientation means is remotely controllable by a control circuit.

84. A hitch assembly, as claimed in claim 83, in which the control circuit has sensor inputs comprising light detectors sensitive to light generated by a laser type levelling sending device, the control circuit evaluating this information to control the orientation means.

85. A hitch assembly, as claimed in claim 84 in which two such light detectors are provided and are mounted to said second frame portion.

86. A hitch assembly, as claimed in claim 83, in which the control circuit is in communication with a GPS positioning arrangement to determine the position of either or both the tractor and a mounted accessory; the control circuit also having provision for receiving data comprising a contour map; the control circuit evaluating GPS and contour map data to control the orientation means.

87. A hitch assembly, as claimed in claim 83, in which the control circuit has outputs for controlling the elevation of a hitch and assembly mounted on the tractor.

88. A hitch assembly, as claimed in claim 83, in which the control circuit has an output for providing information to a display unit visible to an operator.

89. A hitch assembly, as claimed in claim 50, which includes rams for effecting release of accessory mounting pins.

90. A hitch assembly, as claimed in claim 89, in which the pin releasing rams are hydraulic in operation.

91. A hitch assembly, as claimed in claim 89, in which the pin releasing rams are remotely operable from the cab of the tractor or elsewhere on the tractor.

92. A skid steer loader fitted with a hitch assembly, as claimed in claim 50.

93. A method of enabling the rotation of an attachable accessory on a tractor, said rotation being substantially about an axis parallel to the longitudinal axis of the tractor, said method comprising fitting a hitch assembly as claimed in claim 50 intermediate said accessory and tractor.
